(19) United States
(12) Patent Application Publication
(10) Pub. No.: US 2013/0212241 A1
(43) Pub. Date: Aug. 15, 2013

(54) SYSTEM AND METHOD FOR OPERATING NETWORK BASED ON NETWORK VIRTUALIZATION

(71) Applicants: Hyun-Joo KANG, Daejeon-si (KR); Hak-Suh KIM, Daejeon-si (KR); Hyeon-Sik YOON, Daejeon-si (KR); Boo-Geum JUNG, Daejeon-si (KR); Hea-Sook PARK, Daejeon-si (KR)

(72) Inventors: Hyun-Joo KANG, Daejeon-si (KR); Hak-Suh KIM, Daejeon-si (KR); Hyeon-Sik YOON, Daejeon-si (KR); Boo-Geum JUNG, Daejeon-si (KR); Hea-Sook PARK, Daejeon-si (KR)

(73) Assignee: ELECTRONICS AND TELECOMMUNICATIONS RESEARCH INSTITUTE, Daejeon (KR)

(21) Appl. No.: 13/619,045

(22) Filed: Sep. 14, 2012

(30) Foreign Application Priority Data
Feb. 10, 2012 (KR) 10-2012-0013954

(51) Int. Cl. G06F 15/16

(52) U.S. Cl. 709/223

(57) ABSTRACT

A virtual network operating apparatus and method are provided. The virtual network operating method includes configuring, by a virtual network operating apparatus, a plurality of virtual networks identified by domain names, setting, by the virtual network operating apparatus, representative virtual routers representing each of the virtual networks for each virtual network, setting, by the virtual network operating apparatus, representative routing information including an IP address of each of the representative virtual routers in each virtual router included in the virtual networks, and transmitting, by each virtual router, a packet using the set representative routing information.

### CROSS-REFERENCE TO RELATED APPLICATION

This application claims the benefit under 35 U.S.C. §119(a) of Korean Patent Application No. 10-2012-0013954, filed on Feb. 10, 2012, the entire disclosure of which is incorporated herein by reference for all purposes.

### BACKGROUND

1. Field

The following description relates to network virtualization technology, and more particularly, to a network operation service apparatus and method based on network virtualization.

2. Description of the Related Art

Network virtualization, basic technology that can separate a physical infrastructure and an existing Internet service provider (ISP), forms a foundation for creation of new services and expansion of markets, such as in a mobile virtual network operator (MVNO). In today's reality where services through a virtual private network are already used successfully, such as in MPLS VPN technology, it is true that virtualization technology required for cloud computing or future Internet is directed more toward new service creation and market development than toward cost saving. If network virtualization is developing from a method of creating a network based on two layers toward a method of applying L3 mobility technology, then it can be said that cloud computing is developing from a method in which several pieces of network equipment are physically mounted by an equipment manufacturer for future Internet toward a method in which a network is flexibly and scalably created by separating a control plane, a data plane, and a service plane so that a single piece of network equipment can be used to create several networks.

However, cloud computing has a complex network and is only a technique for supporting a virtual private network based on the network provider not the service provider. Accordingly, there is demand for a mechanism that can support network virtualization based on services for future Internet.

### RELATED ART DOCUMENTS

### Patent Documents

(Patent Document 1) Application No: 10-2008-7015037, Applicant: International Business Machines Corporation, Title: Virtual Network Operation Method, Data Network System, Computer Program, and Computer Program Product

### SUMMARY

The following description relates to a system and method for operating a network based on network virtualization that can provide scalability and flexibility of a virtual network using a method for identifying the virtual network based on network services.

In one general aspect, there is provided a virtual network operating method based on a virtual network, including: configuring, by a virtual network operating apparatus, a plurality of virtual networks identified by domain names; setting, by the virtual network operating apparatus, representative virtual routers representing each of the virtual networks for each virtual network; setting, by the virtual network operating apparatus, representative routing information including an IP address of each of the representative virtual routers in each virtual router included in the virtual networks; and transmitting, by each virtual router, a packet using the set representative routing information.

In another general aspect, there is provided a virtual network operating apparatus, including: a resource management unit that manages network resources; a virtual network control unit that configures a plurality of virtual networks identified by domain names, sets a representative virtual router representing each of the virtual networks, and sets representative routing information including an IP address of each of the representative virtual routers in each of the virtual routers included in the virtual networks; a virtual network configuration information database (DB) that stores the IP address of each of the representative virtual routers corresponding to each of the domain names; and a virtual network profile DB that stores a profile of each of the virtual networks.

In still another general aspect, there is provided a router included in a virtual network, including: a representative virtual router table that stores an IP address of a representative virtual router of each of a plurality of virtual networks identified by domain names; and a routing control unit that receives a transmission packet including a domain name to which a reception host device belongs as destination information from a transmission host device, searches for the IP address of the representative virtual router of the virtual network to which the reception host device belongs using the domain name to which the reception host device belongs, and transmits the transmission packet to the IP address of the representative virtual router.

Other features and aspects will be apparent from the following detailed description, the drawings, and the claims.

### BRIEF DESCRIPTION OF THE DRAWINGS

FIG. 1 is a diagram illustrating a virtual network system according to an embodiment of the present invention;

FIG. 2 is a diagram illustrating a configuration of an apparatus for operating a network according to an embodiment of the present invention;

FIG. 3 is a diagram illustrating a configuration of a virtual network configuration information database (DB) according to an embodiment of the present invention;

FIG. 4 is a diagram illustrating a configuration of a virtual network profile DB according to an embodiment of the present invention;

FIG. 5 is a diagram illustrating a configuration of a virtual router according to an embodiment of the present invention;

FIG. 6 is a diagram illustrating a configuration of a host information table of FIG. 5 according to an embodiment of the present invention;

FIG. 7 is a diagram illustrating a configuration of a representative virtual router table according to an embodiment of the present invention;

FIG. 8 is a diagram illustrating a configuration of a link local address table of FIG. 5 according to an embodiment of the present invention;

FIG. 9 is a diagram illustrating a configuration of a connection virtual router table of FIG. 5 according to an embodiment of the present invention;

FIG. 10 is a diagram schematically illustrating a method for transmitting a packet in a virtual network according to an embodiment of the present invention;

FIG. 11 is a diagram illustrating a structure of a packet transmitted from a virtual router VR1 according to an embodiment of the present invention; and

FIG. 12 is a diagram illustrating a structure of a packet transmitted from a virtual router VR2 according to an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

Hereinafter, preferred embodiments of the present invention will be described in detail with reference to accompanying drawings.

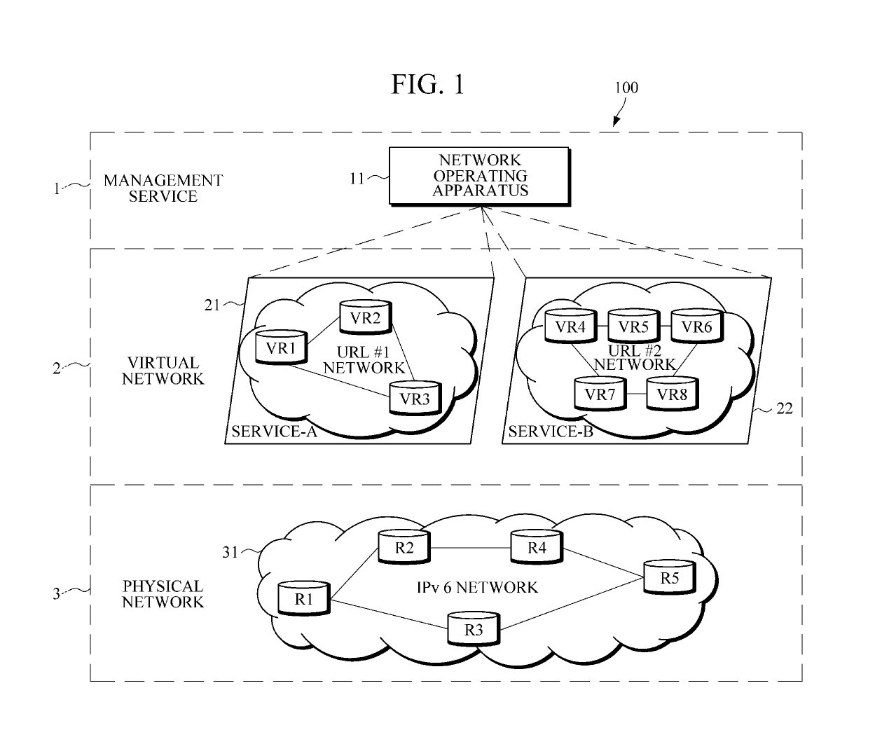

FIG. 1 is a diagram illustrating a virtual network system according to an embodiment of the present invention.

The virtual network system 100 of FIG. 1 may have a three-tiered hierarchical structure.

The virtual network system 100 includes a management service layer 1, a virtual network layer 2, and a physical network layer 3.

The physical network layer 3 includes a plurality of packet processing apparatuses R1, R2, R3, R4, and R5 such as routers. Here, it is assumed that the packet processing apparatuses are routers.

The virtual network layer 2 is configured based on the physical network layer 3.

The virtual network layer 2 may include virtual networks 21 and 22 providing mutually different network services.

The management service layer 1 configures and manages the virtual network layer 2.

In the management service layer 1, a network operation apparatus 11 for operating and controlling the virtual network layer 2 is positioned. The network operation apparatus 11 operates and controls the virtual network layer 2 using a domain name as identification (ID) information of the virtual network.

The network operation apparatus 11 may configure the virtual network layer 2 by adopting a network virtualization method based on the physical network layer 3.

As an example, the virtual network layer 2 may be configured such that a virtual interface (or logical interface) other than a physical interface with respect to a physical port of each router of the physical network layer 3 is set. A virtual IP address may be assigned to the logical interface. In this case, packet transmission/reception may be performed via a method of borrowing the physical interface based on the virtual IP address.

As another example, the virtual network layer 2 may be configured such that a network system itself is virtualized. That is, the virtual network layer 2 is physically one, but an interface or the like, in addition to a routing protocol and system management, may share and use resources as if several systems are present.

The network operation apparatus 11 assigns a domain name (or uniform resource locator (URL)) for each virtual network by dividing the virtual networks into service units, a user group unit, an institution or corporation unit, a location unit, and the like. Here, the assigning denotes setting routing or forwarding information toward virtual routers VR1, VR2, VR3, VR4, VR5, VR6, VR7, and VR8 of the virtual network layer 2, which is configured based on physical routers R1, R2, R3, R4, and R5 of the physical network 3.

As shown in FIG. 1, the virtual network 21 may be configured using a name of URL #1 for Service-A, and the virtual network 22 may be configured using a name of URL #2 for Service-B.

The virtual networks 21 and 22 are independent and used with a focus on a reception-side URL of a user when a transmission-side URL of the user and the reception-side URL are present. Here, the two virtual networks 21 and 22 identified by two domain names are included in the network layer 2, but the network layer 2 may be configured such that at least three virtual networks are identified by corresponding domain names.

At the time of implementation, information for virtual network configuration may be included in each router R1, R2, R3, R4, and R5 of the physical network layer 3, and each router R1, R2, R3, R4, and R5 may transmit information for configuring the virtual network to neighboring routers, or the information for configuring the virtual network may be propagated using a virtual network in the form of query and response between the routers.

In this manner, the network operation apparatus 11 may generate the virtual routers VR1, VR2, VR3, VR4, VR5, VR6, VR7, and VR8 included in the virtual network layer 2 using resources of the routers R1, R2, R3, R4, and R5 of the at least one physical network layer 3.

Each of the virtual routers VR1, VR2, VR3, VR4, VR5, VR6, VR7, and VR8 may be classified into a representative virtual router acting as the entrance and exit through which packets of the virtual networks 21 and 22 are transmitted, and a connection virtual router to which a host device (not shown) is connected. Here, the host device may be a terminal device that transmits and receives packets through the virtual routers of the virtual network 2. ID information of each host device may include a domain name of the virtual network to is which each host device is connected to use network services.

When it is assumed that the representative virtual router of the virtual network 21 is the virtual router VR1, the representative virtual router VR1 transmits/receives packets to/from the other virtual network 22.

A single virtual router may act as both the representative virtual router and the connection virtual router, or the representative virtual router and the connection virtual router may be separate.

In a typical network, packets are exchanged using a source IP (or a transmission IP address) and a destination IP (or a reception IP address).

According to an embodiment, in the virtual network layer 2, in a case of end-to-end communication, a transmission packet includes a domain name (URL) to which a reception host device belongs as destination information. Accordingly, the transmission packet is transmitted using a destination URL (or reception-side URL) instead of a typical reception IP.

It is assumed that multimedia services are provided to a user only when the user has subscribed to a specific network provider. In this case, the user may not be provided with the services when using networks of other service providers.

However, in the network virtualization, a large number of network providers are connected (scalable concept of current MVNO) through a single virtual network, so that users are connected in service units to thereby conveniently use corresponding services.

In addition, in an organization network, premium services may be provided through the virtual network in such a manner as to combine a National Assembly network and the organization network.

Even though conversion to an IPv6 system is underway because IPv4 addresses are depleted and NAT/PT is complicated, there are mobility support problems because a domain name system (DNS) is time-consuming to change. However, when configuring the virtual network in small units, that is, service units, a recognizable URL is used and services may be provided based on IPv6 within the network.

In addition, a BGP entry congestion problem occurs when host routing is increased in a network of large units while mobility is basically ensured, or when traffic engineering such as quality assurance (QoS) or the like is added. Accordingly, when a URL is used as virtual network identification information, mobility is achieved within the corresponding virtual network, thereby solving the BCG entry congestion problem.

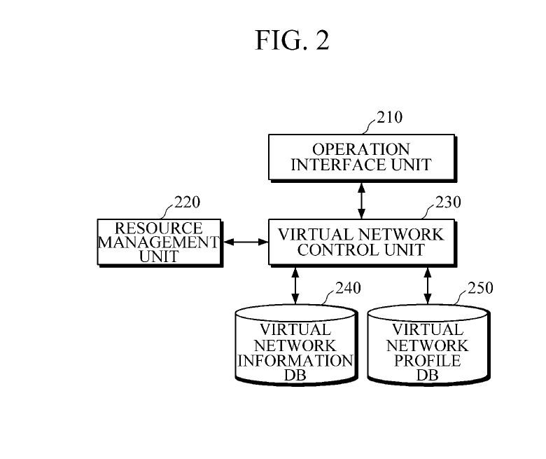

FIG. 2 is a diagram illustrating a configuration of a network operating apparatus 11 according to an embodiment of the present invention.

The network operating apparatus 11 includes an operation interface unit 210, a resource management unit 220, a virtual network control unit 230, a virtual network configuration information database (DB) 240, and a virtual network profile DB 250.

The operation interface unit 210 is configured such that virtual network configuration information is manually registered, modified, or deleted by a specific protocol or a network operator. A domain name (URL) identifying a virtual network, an IP address of a representative virtual router of each of a plurality of virtual networks, or the like may be received through the operation interface unit 210.

The operation interface unit 210 may receive virtual network profile information.

The operation interface unit 210 transmits the virtual network configuration information and the virtual network profile information to the virtual network control unit 230.

The resource management unit 220 is managed by the network operation apparatus 11, and manages all physical network topologies and resource configuration information used in configuration of the virtual network.

The virtual network control unit 230 configures a plurality of virtual networks identified by domain names, sets a representative virtual router representing virtual routers included in each of the virtual networks, and sets representative routing information including an IP address of each of the representative virtual routers in each of the virtual routers.

In addition, the virtual network control unit 230 generates a response to a query for the domain name from the virtual routers of the virtual network layer 2.

The virtual network control unit 230 internally reads and writes information from the virtual network configuration information DB 240 and the virtual network profile DB 250.

The virtual network control unit 230 transmits, to the virtual network layer 2, the virtual network configuration information updated through the operation interface unit 210 and network resource information updated through the resource management unit 220, and service information and the like of the virtual network may be changed and propagated.

The virtual network configuration information DB 240 and the virtual network profile DB 250 are configured and managed to be used to configure and operate a corresponding virtual network in conjunction with a router on the physical topology.

The virtual network configuration information DB 240 includes the representative routing information including the IP address of the representative virtual router set in each of the virtual networks while representing each of the configured virtual networks.

The virtual network configuration information DB 240 may include the IP address of the representative virtual router corresponding to the domain name identifying each of the virtual networks.

The virtual network profile DB 250 stores network profile information with respect to the virtual network. A network profile may include information about services provided by the corresponding virtual network.

The virtual network profile DB 250 may include at least one of a service level specification (SLS), a QoS policy, and a security policy of each of the virtual networks.

When the representative routing information including the IP address of the representative virtual router set in the virtual network configuration information DB 240 is updated, the virtual network control unit transmits the updated representative routing information to the virtual routers included in the virtual network so that each of the virtual routers may update virtual network information.

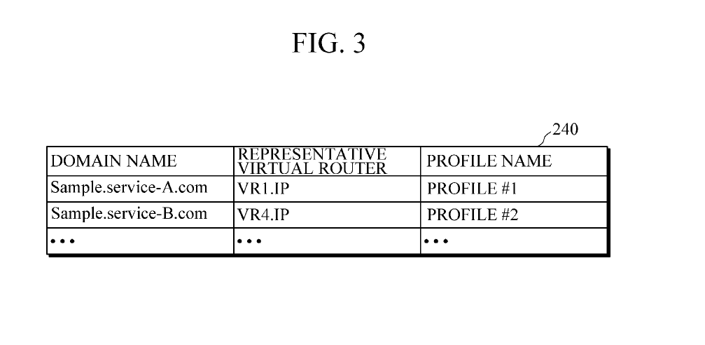

FIG. 3 is a diagram illustrating a configuration of a virtual network configuration information database (DB) according to an embodiment of the present invention.

The virtual network configuration information table 200 may include a domain name field, a representative network system field, and a profile name field.

The domain name field indicates a name of the virtual network. For example, a first virtual network of FIG. 1 has a virtual network name of sample.service-A.com, and a second virtual network has a virtual network name of sample.service-B.com.

The representative virtual router field includes information about the representative virtual router included in each of the virtual networks. The virtual network may include at least one representative virtual router in accordance with a service scale provided by the corresponding virtual network.

For example, a representative virtual router field of the first virtual network may include a name VR1 of the representative virtual router and an IP address of the VR1.

A representative virtual router field of the second virtual network may include a name VR4 of the representative virtual router and an IP address of the VR4.

The profile name is a parameter for describing characteristics of a corresponding virtual network, and may be configured to be linked with the virtual network profile DB 250.

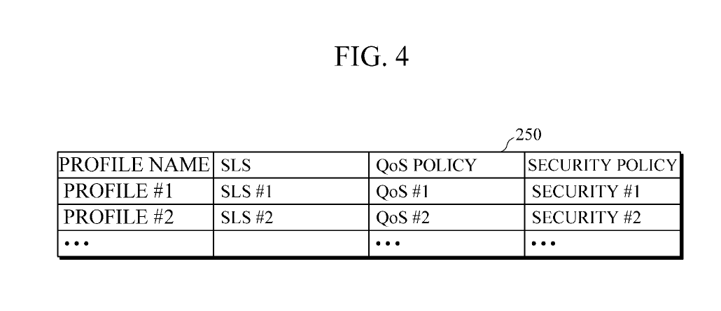

FIG. 4 is a diagram illustrating a configuration of a virtual network profile DB according is to an embodiment of the present invention.

The virtual network profile DB 250 may include a profile name field, an SLS field, a QoS policy field, and a security policy field.

Each of profiles may further include a maximum or minimum number of service hosts, host location information, and the like which are not shown in FIG. 4.

As shown in FIGS. 3 and 4, by configuring the virtual network configuration information DB 240 and the virtual network profile DB 250, the same profile may be used in several virtual network services.

Alternatively, the virtual network profile DB 250 may be configured to include profile information corresponding to the domain name of each of the virtual networks.

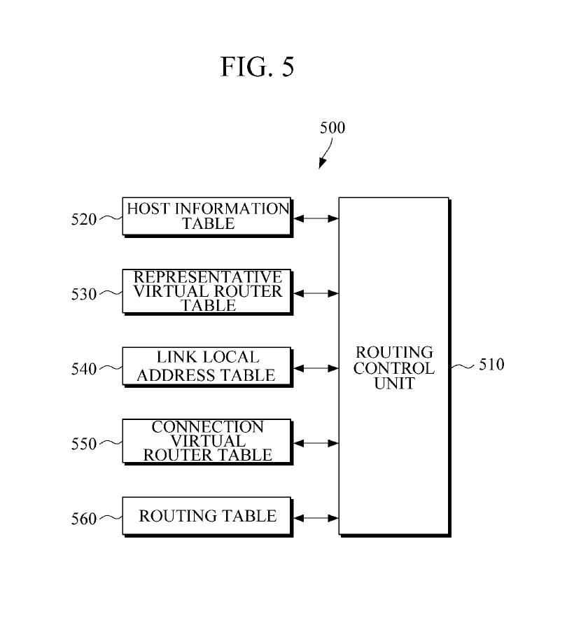

FIG. 5 is a diagram illustrating a configuration of a virtual router according to an embodiment of the present invention.

Referring to FIG. 5, the virtual router 500 includes a routing control unit 510, a host information table 520, a representative virtual router table 530, a link local address table 540, a connection virtual router table 550, and a routing table 560.

The routing control unit 510 performs routing with respect to packets using the host information table 520, the representative virtual router table 530, the link local address table 540, the connection virtual router table 550, and the routing table 560.

It is not necessary for all the virtual routers of the virtual network layer 2 to include the host information table 520, the representative virtual router table 530, the link local address table 540, the connection virtual router table 550, and the routing table 560. That is, the virtual router may selectively include the host information table 520, the representative virtual router table 530, the link local address table 540, the connection virtual router table 550, and the routing table 560 in accordance with functions of each of the virtual routers.

For example, the virtual router which acts as the representative virtual router and does not act as the connection virtual router may not include the link local address table 540.

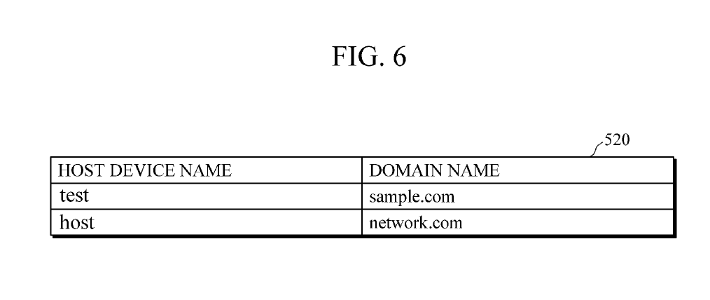

FIG. 6 is a diagram illustrating a configuration of the host information table 520 of FIG. 5 according to an embodiment of the present invention.

The host information table 520 stores a name of a host device (not shown) and a domain name. That is, the host device and the domain name of the corresponding host device are mapped in the host information table 520.

Information including the host device name and the domain name of the host information table 520 may be used as a host identifier for identifying the host device.

Accordingly, using the host identifier according to an embodiment, services used by the corresponding virtual network may be identified, so that the domain name may be used for identifying the host device.

The host device may be used for transmitting/receiving packets using the identifier of the host device according to an embodiment.

The virtual router 500 may determine whether the connected host device has authority to use the network services using information of the host information table 520.

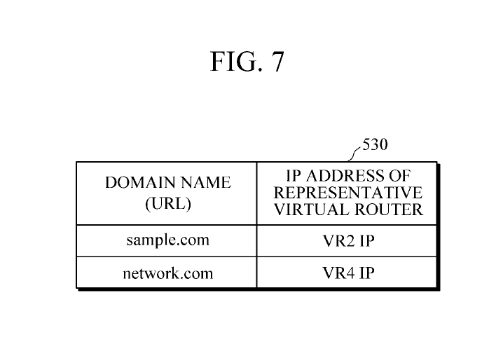

FIG. 7 is a diagram illustrating a configuration of a representative virtual router table 530 according to an embodiment of the present invention.

The representative virtual router table 530 stores a domain name and an IP address of a representative virtual router corresponding to an entrance and exit of a corresponding domain. That is, the IP address of the representative virtual router corresponding to the entrance and exit corresponding to the domain name is mapped in the representative virtual router table 530.

For example, as shown in FIG. 7, a domain name (sample.com) and an IP address (VR2 IP) of the representative virtual router of the corresponding domain are mapped in the representative virtual router table 530, so that, when the domain name (sample.com) is included as destination information (D_URL) of a transmission packet, the corresponding packet is transmitted to the IP address (VR2 IP) of the representative virtual router (VR2).

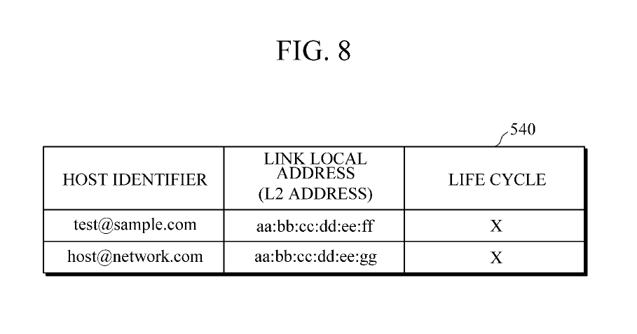

FIG. 8 is a diagram illustrating a configuration of the link local address table 540 of FIG. 5 according to an embodiment of the present invention.

A host identifier and link local information are mapped and stored in the link local address table 540. A media access control (MAC) address, an Ethernet address, or the like may be included in the link local address.

For example, as shown in FIG. 8, a host identifier (test@ sample.com) and a link local address (aa:bb:cc:dd:ee:ff) are mapped in the link local address table 540, so that the virtual router 500 may transmit, to an L2 address of aa:bb:cc:dd:ee:ff, a transmission packet having a host identifier (test@ sample) including a domain name of sample.com as a destination address.

In addition, when there is no packet flow to the link local address, the link local address table 540 may further include life cycle information for releasing a mapping relationship between the domain name and the link local address so as to correspond to the corresponding link local information.

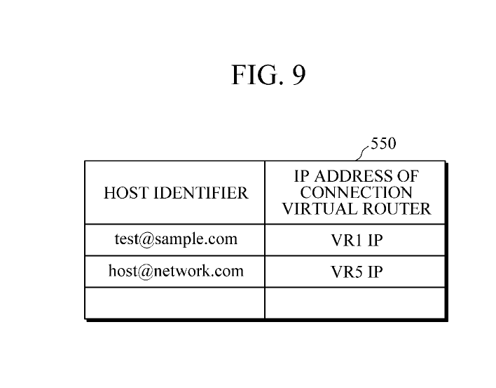

FIG. 9 is a diagram illustrating a configuration of a connection virtual router table 550 of FIG. 5 according to an embodiment of the present invention.

The connection virtual router table 550 stores an IP address of a connection router to which at least one host device included in the virtual network to which the representative virtual router belongs is connected. For example, a host device identified by a host identifier (test@ sample.com) may indicate that it is currently connected to a virtual router (VR1).

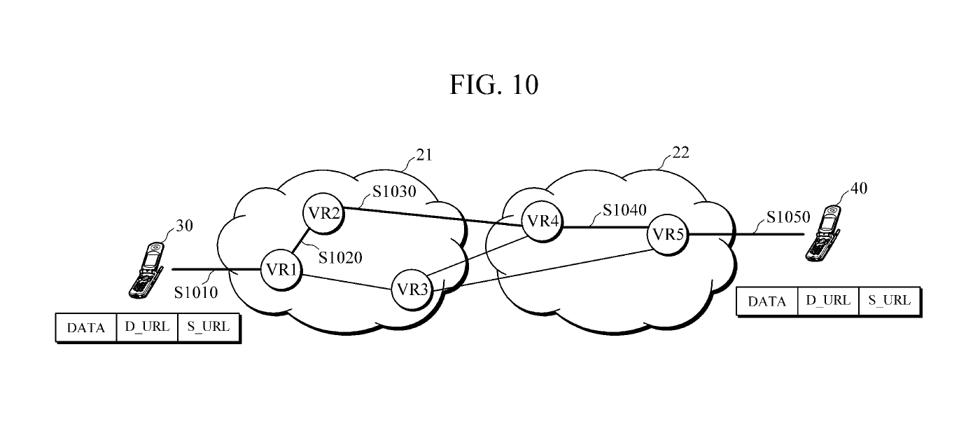

Hereinafter, a packet transmission method in the virtual networks 21 and 22 will be described in detail with reference to FIGS. 10 to 12.

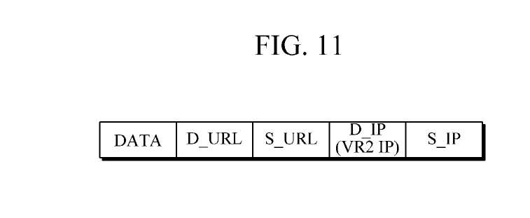

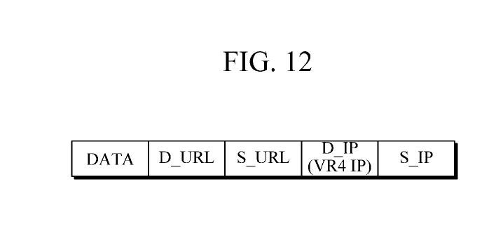

FIG. 10 is a diagram schematically illustrating a packet transmission method in a virtual network according to an embodiment of the present invention, FIG. 11 is a diagram illustrating a structure of a packet transmitted from a virtual router VR1 according to an embodiment of the present invention, and FIG. 12 is a diagram illustrating a structure of a packet transmitted from a virtual router VR2 according to an embodiment of the present invention.

Referring to FIG. 10, a transmission host device 30 adds, to a data field including data to be transmitted, a transmission URL field (S_URL) in which an identifier (test@ sample.com) of a transmission host device 30 is set as starting point information and a reception URL field (D_URL) in which an identifier (host@network.com) of a reception host device 40 corresponding to a destination of a packet is set, and generates a transmission packet to be transmitted.

In operation S1010, the transmission host device 30 transmits the generated transmission packet to a connection virtual router VR1.

In operation 1020, the connection virtual router VR1 verifies starting point information of the transmission host device 30 to thereby transmit the transmission packet to a representative virtual router VR2 of a virtual network 21 identified by a domain name (sample.com) included in the starting point information.

In this instance, the connection virtual router VR1 may add, to the received transmission packet, a reception IP field (D_IP) for setting an IP address (VR2 IP) of the representative virtual router VR2 and a transmission IP field (S_IP) for setting an IP address (VR1 IP) of the connection virtual router VR1 to thereby transmit.

That is, the packet transmitted from the virtual router R1 is provided as shown in FIG. 11, and the reception IP field (D_IP) and the transmission IP field (S_IP) correspond to an external header.

The representative virtual router VR2 verifies an identifier of the reception host device 40 included in destination information (D_URL) of the transmission packet to thereby verify a domain name to which the transmission packet is transmitted.

In operation S1030, the representative virtual router VR2 verifies an IP address (VR4 IP) of a representative virtual router VR4 corresponding to a domain name (network.com) of the reception host device 40 with reference to a virtual router table 530 described with reference to FIG. 7, and then transmits the transmission packet to the representative virtual router VR4.

In this instance, the representative virtual router VR2 transmits the transmission packet along a routing path which is set in accordance with a routing table. The packet transmitted from the virtual router R2 is provided as shown in FIG. 7.

When receiving the packet, the representative virtual router VR4 determines whether the IP address of the reception IP field (D_IP) coincides with an IP address of the representative virtual router VR4.

When the IP address of the reception IP field (D_IP) coincides with the IP address of the representative virtual router VR4, the representative virtual router VR4 inspects the reception URL field (D_URL) of the corresponding packet to thereby verify a host identifier of the reception host device 40.

In operation S1040, the representative virtual router VR4 verifies a connection virtual router VR5 to which the reception host device 40 is connected, based on a connection virtual router table described with reference to FIG. 9, and transmits the transmission packet to the connection virtual router VR5.

In operation S1050, the connection virtual router VR5 searches for a link local address using the host identifier of the reception host device 40 included in the destination information (D_URL) of the transmission packet, based on the link local address table described with is reference to FIG. 8, and transmits the transmission packet to the link local address.

Then, the reception host device 40 receives the corresponding packet.

As described above, according to the embodiments of the present invention, in the virtual network, a packet may be transmitted using an identifier of a host device including a domain name, thereby separating location information such as an IP address and the identifier of the host device. Accordingly, complexity of mobility support which is caused by using the IP address as the identifier and the location information may be reduced.

According to embodiments of the present invention, when the virtual network is constructed using the domain name, services based not on a network provider but on a network service user or a network service can be provided, services can be easily created, and existing technology can be applied to future Internet.

In addition, the host can be identified, and a location of the host can be identified through the virtual network using the domain name, thereby solving a mobility support complexity problem, a scalability problem, a BGP entry congestion problem, and the like.

The present invention can be implemented as computer-readable codes in a computer-readable recording medium. The computer-readable recording medium includes all types of recording media in which computer-readable data are stored. Examples of the computer-readable recording medium include a ROM, a RAM, a CD-ROM, a magnetic tape, a floppy disk, and an optical data storage. Further, the recording medium may be implemented in the form of carrier waves such as employed in Internet transmission. In addition, the computer-readable recording medium may be distributed to computer systems over a network, in which computer-readable codes may be stored and executed in a distributed manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A virtual network operating method based on a virtual network, comprising:
configuring, by a virtual network operating apparatus, a plurality of virtual networks identified by domain names;
setting, by the virtual network operating apparatus, representative virtual routers representing each of the virtual networks for each virtual network;
setting, by the virtual network operating apparatus, representative routing information including an IP address of each of the representative virtual routers in each virtual router included in the virtual networks; and
transmitting, by each virtual router, a packet using the set representative routing information.

2. The virtual network operating method according to claim 1, wherein the packet is includes a domain name to which a reception host device belongs as destination information of the packet.

3. The virtual network operating method according to claim 1, further comprising:
receiving, by the virtual router, a transmission packet including a domain name to which a reception host device belongs as destination information of the packet from a transmission host device;
searching for, by the virtual router, the IP address of the representative virtual router of the virtual network to which the reception host device belongs using the domain name to which the reception host device belongs; and
transmitting the transmission packet to the IP address of the representative virtual router.

4. The virtual network operating method according to claim 3, further comprising:
managing, by the virtual router, a representative virtual router table including the IP address of the representative virtual router corresponding to the domain name of each of the virtual networks.

5. The virtual network operating method according to claim 3, further comprising:
managing, by the virtual router, a link local address table indicating a link local address with respect to at least one host device included in the virtual network to which the virtual router belongs.

6. The virtual network operating method according to claim 5, further comprising:
searching for, by the virtual router, a link local address of the reception host device included in the transmission packet from the link local address table including the link local is address with respect to the at least one host device; and
transmitting, by the virtual router, the transmission packet to the link local address of the reception host device.

7. The virtual network operating method according to claim 1, further comprising:
managing, by each of the representative virtual routers, a connection virtual router table indicating an IP address with respect to a connection virtual router to which at least one host included in the virtual network to which each of the representative virtual routers belongs is connected;
searching for, by each of the representative virtual routers, the IP address of the connection virtual router to which a reception host device is connected from the connection virtual router table when receiving a transmission packet including a domain name to which a reception host device belongs from a router belonging to another virtual network; and
transmitting, by each of the representative virtual routers, the transmission packet to the connection virtual router having the IP address of the connection virtual router.

8. The virtual network operating method according to claim 1, further comprising:
managing, by the virtual network operating apparatus, a virtual network configuration information database (DB) including the representative routing information including the IP address of each of the set representative virtual routers.

9. The virtual network operating method according to claim 8, further comprising:
transmitting, by the virtual network operating apparatus, updated representative routing information to the each of the virtual routers of the virtual networks when the representative routing information is updated.

10. The virtual network operating method according to claim 1, further comprising:
managing, by the virtual network operating apparatus, a virtual network profile DB including at least one of a service level specification (SLS), a QoS policy, a security policy of each virtual network.

11. A virtual network operating apparatus, comprising:
a resource management unit that manages network resources;
a virtual network control unit that configures a plurality of virtual networks identified by domain names, sets a representative virtual router representing each of the virtual networks, and sets representative routing information including an IP address of each of the representative virtual routers in each of the virtual routers included in the virtual networks;
a virtual network configuration information DB that stores the IP address of each of the representative virtual routers corresponding to each of the domain names; and
a virtual network profile DB that stores a profile of each of the virtual networks.

12. The virtual network operating apparatus according to claim 11, wherein, when the representative routing information including the IP address of the representative virtual router stored in the virtual network configuration information DB is updated, the virtual network control unit transmits the updated representative routing information to each of the virtual routers.

13. The virtual network operating apparatus according to claim 11, further comprising:
an operation interface unit that receives virtual network configuration information used in configuring each of the virtual networks and profile information of the virtual network, and is transmits the virtual network configuration information and the profile information to the virtual network control unit.

14. The virtual network operating apparatus according to claim 11, wherein a transmission packet including a domain name to which a reception host device belongs as destination information is transmitted and received based on the configured virtual network.

15. A router included in a virtual network, comprising:
a representative virtual router table that stores an IP address of a representative virtual router of each of a plurality of virtual networks identified by domain names; and
a routing control unit that receives a transmission packet including a domain name to which a reception host device belongs as destination information from a transmission host device, searches for the IP address of the representative virtual router of the virtual network to which the reception host device belongs using the domain name to which the reception host device belongs, and transmits the transmission packet to the IP address of the representative virtual router.

16. The router according to claim 15, further comprising:
a link local address table that indicates a link local address with respect to at least one host identifier included in each of the virtual networks,
wherein the routing control unit searches for the link local address with respect to identification (ID) information of the reception host device included in packet destination information of the transmission packet, and transmits the transmission packet to the reception host device having the link local address.

17. The router according to claim 15, further comprising:
a connection virtual router table that stores an IP address of a connection virtual router to which at least one host included in the virtual network to which the representative virtual router belongs is connected,
wherein, when receiving the transmission packet including the domain name to which the reception host device belongs from the virtual router included in another virtual network, the routing control unit searches for the IP address of the connection virtual router to which the reception host device is connected from the connection virtual router table, and transmits the transmission packet to the connection virtual router having the IP address of the searched connection virtual router.
